(19) United States
(12) Patent Application Publication
(10) Pub. No.: US 2020/0335242 A1
(43) Pub. Date: Oct. 22, 2020

(54) Multiple Circuits Wiring Assembly

(71) Applicant: Raul Caperon, Apache Junction, AZ (US)

(72) Inventor: Raul Caperon, Apache Junction, AZ (US)

(21) Appl. No.: 16/387,254

(22) Filed: Apr. 17, 2019

(51) Int. Cl. H01B 7/36; H01B 7/02; H01B 7/20; H01B 7/00

(52) U.S. Cl. CPC H01B 7/361; H01B 7/0009; H01B 7/20; H01B 7/02

(57) ABSTRACT

A multiple circuit wiring assembly for discretely wiring a plurality of circuits with a single cable includes a set of first conductors each being placed in electrical communication with a first circuit. A set of second conductors is provided and each of the second conductors is each placed in electrical communication with a second circuit. A set of third conductors is provided and each of the third conductors is placed in electrical communication with a third circuit. Each of the sets of first, second and third conductors supplies a discrete power, neutral and ground for the respective first, second and third circuits. A sleeve is positioned around each of the sets of first, second and third conductors.

### CROSS-REFERENCE TO RELATED APPLICATION

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98.

The disclosure and prior art relates to wiring devices and more particularly pertains to a new wiring device for discretely wiring a plurality of circuits with a single cable.

### BRIEF SUMMARY OF THE INVENTION

An embodiment of the disclosure meets the needs presented above by generally comprising a set of first conductors each being placed in electrical communication with a first circuit. A set of second conductors is provided and each of the second conductors is each placed in electrical communication with a second circuit. A set of third conductors is provided and each of the third conductors is placed in electrical communication with a third circuit. Each of the sets of first, second and third conductors supplies a discrete power, neutral and ground for the respective first, second and third circuits. A sleeve is positioned around each of the sets of first, second and third conductors.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a multiple circuit wiring assembly according to an embodiment of the disclosure.

FIG. 2 is a cross sectional view taken along line 2-2 of FIG. 1 of an embodiment of the disclosure.

FIG. 3 is a perspective view of an alternative embodiment of the disclosure.

### DETAILED DESCRIPTION OF THE INVENTION

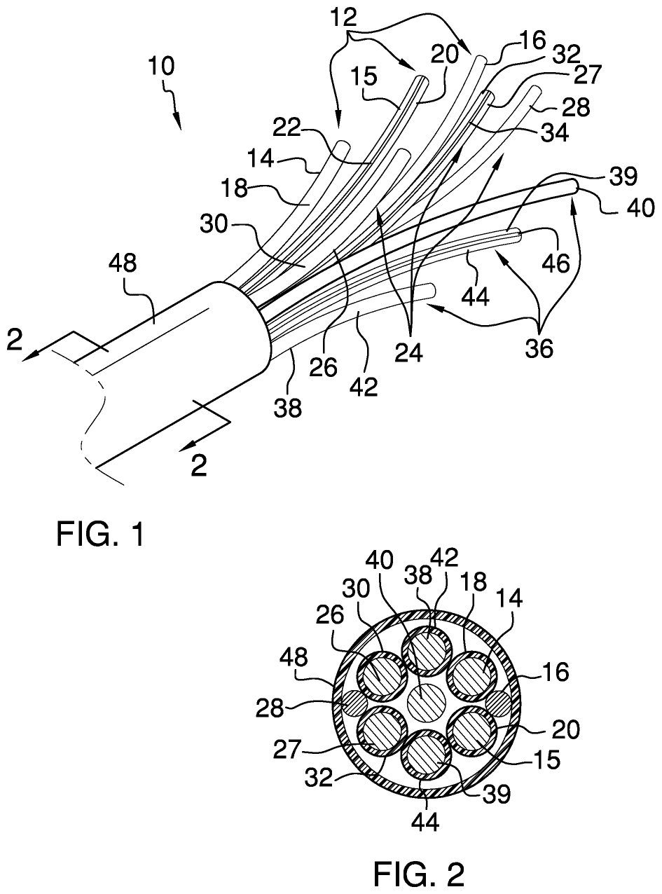

With reference now to the drawings, and in particular to FIGS. 1 through 3 thereof, a new wiring device embodying the principles and concepts of an embodiment of the disclosure and generally designated by the reference numeral 10 will be described.

As best illustrated in FIGS. 1 through 3, the multiple circuits wiring assembly 10 generally comprises a set of first conductors 12. Each of the first conductors 12 is placed in electrical communication with a first circuit to supply power, neutral and ground for the first circuit. The first circuit may be an electrical circuit in a residential building, a commercial building or any other electrical circuit that must comply with National Electrical Code. The set of first conductors 12 includes a first power conductor 14, a first neutral conductor 15 and a first ground conductor 16. The first power conductor 14 has insulated sheathing 18 and the insulated sheathing 18 on the first power conductor 14 has a first color, which may be black. The first neutral conductor 15 has insulated sheathing 20 and the insulated sheathing 20 on the first neutral conductor 15 has a stripe thereon 22. The stripe 22 is colored to correspond to the first color thereby facilitating the first neutral conductor 15 to be visually identifiable as the neutral for the first circuit.

A set of second conductors 24 is provided and each of the second conductors 24 is placed in electrical communication with a second circuit. In this way the set of second conductors 24 can supply power, neutral and ground for the second circuit. The second circuit may be an electrical circuit in a residential building, a commercial building or any other electrical circuit that must comply with National Electrical Code. The set of second conductors 24 includes a second power conductor 26, a second neutral conductor 27 and a second ground conductor 28. The second power conductor 26 has insulated sheathing 30 and the insulated sheathing 30 on the second power conductor 26 has a second color, which may be red. The second color is a color that is distinct from the first color. The second neutral conductor 27 has insulated sheathing 32 and the insulated sheathing 32 on the second neutral conductor 27 has a stripe 34 thereon. The stripe 34 on the second neutral conductor 27 is colored to correspond to the second color to facilitate the second neutral conductor 27 to be visually identifiable as the neutral for the second circuit.

A set of third conductors 36 is provided and each of the third conductors 36 is placed in electrical communication with a third circuit. Thus, the set of third conductors 36 can supply power, neutral and ground for the third circuit. The third circuit may be an electrical circuit in a residential building, a commercial building or any other electrical circuit that must comply with National Electrical Code. The set of third conductors 36 includes a third power conductor, 38 a third neutral conductor 39 and a third ground conductor 40. The third power conductor 38 has insulated sheathing 42 and the insulated sheathing 42 on the third power conductor 38 has a third color, which may be blue. The third color is distinct from the first and second colors. The third neutral conductor 39 has insulated sheathing 44 and the insulated sheathing 44 on the third neutral conductor 39 has a stripe 46 thereon. The stripe 46 on the third neutral conductor 39 is colored to correspond to the third color thereby facilitating the third neutral conductor 39 to be visually identifiable as the neutral for the third circuit.

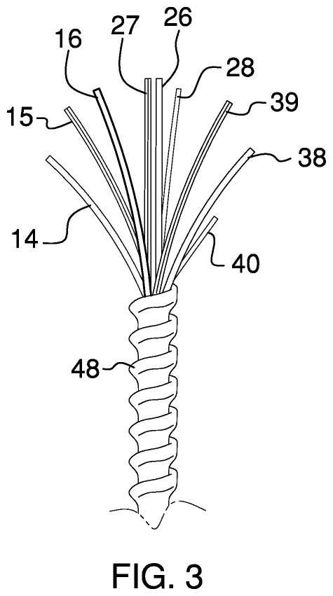

A sleeve 48 is positioned around each of the sets of first 12, second 24 and third 36 conductors. As is most clearly shown in FIGS. 1 and 2, the sleeve 48 may comprise a flexible, electrically insulating material. Additionally, the sleeve 48 may be colored yellow in accordance to National Electrical Code when the first, second and third sets of conductors are 12 AWG conductors. The sleeve 48 may be colored white in accordance to National Electrical Code when the first, second and third sets of conductors are 14 AWG conductors. As is most clearly shown in FIG. 3, the sleeve 48 may be a metallic material in the convention of metal clad cable. Moreover, only the first 12 and second 24 sets of conductors may be present thereby facilitating the assembly to service a pair of independent circuits.

In use, each of the first 14, second 24 and third 36 sets of conductors are routed along a selected path for wiring a plurality of circuits in a building or the like. Each of the first 14, second 24 and third 36 sets of conductors includes a discrete ground with respect to each other. In this way an electrician or other installer can wire three separate circuits with a single cable rather than having to run multiple cables to service the separate circuits. Additionally, the coloring associated with each of the first 14, second 26 and third 36 sets of conductors enhance visually identifying the power, neutral and ground for each circuit. In this way the likelihood of making mistakes while wiring the circuits is reduced.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A multiple circuit wiring assembly being configured to supply independent power and ground for a plurality of circuits, said assembly comprising:
a set of first conductors, each of said first conductors being placed in electrical communication with a first circuit wherein said set of first conductors is configured to supply power, neutral and ground for said first circuit, said set of first conductors including a first power conductor, a first neutral conductor and a first ground conductor, each of said first power and neutral conductors having insulated sheathing;
a set of second conductors, each of said second conductors being placed in electrical communication with a second circuit wherein said set of second conductors is configured to supply power, neutral and ground for said second circuit, said set of second conductors including a second power conductor, a second neutral conductor and a second ground conductor, each of said second power and neutral conductors having insulated sheathing;
a set of third conductors, each of said third conductors being placed in electrical communication with a third circuit wherein said set of third conductors is configured to supply power, neutral and ground for said third circuit, said set of third conductors including a third power conductor, a third neutral conductor and a third ground conductor, each of said third power and neutral conductors having insulated sheathing;
a sleeve being positioned around each of said sets of first, second and third conductors; and
wherein said third ground conductor is centrally positioned extending along said sleeve, said first power conductor, said first neutral conductor, said second power conductor, said second neutral conductor, said third power conductor, and said third neutral conductor being arranged into a ring around said third ground conductor extending along said sleeve, each of said first ground conductor and said second ground conductor being positioned extending along said sleeve on diametrically opposed sides of said ring.

2. The assembly according to claim 1, wherein said insulated sheathing of said first power conductor having a first color.

3. The assembly according to claim 2, wherein said insulated sheathing on said first neutral conductor has a stripe thereon being colored to correspond to said first color wherein said first neutral conductor is configured to be visually identifiable as the neutral for the first circuit.

4. The assembly according to claim 2, wherein said insulated sheathing having a second color.

5. The assembly according to claim 4, wherein said insulated sheathing on said second neutral conductor has a stripe thereon being colored to correspond to said second color wherein said second neutral conductor is configured to be visually identifiable as the neutral for the second circuit.

6. The assembly according to claim 4, wherein said insulated sheathing having a third color.

7. The assembly according to claim 6, wherein said insulated sheathing on said third neutral conductor has a stripe thereon being colored to correspond to said third color wherein said third neutral conductor is configured to be visually identifiable as the neutral for the third circuit.

8. The assembly according to claim 1, wherein said sleeve is colored according to National Electrical Code with respect to the American Wire Gauge of said sets of first, second and third conductors.

9. A multiple circuit wiring assembly being configured to supply independent power and ground for a plurality of circuits, said assembly comprising:
a set of first conductors, each of said first conductors being placed in electrical communication with a first circuit wherein said set of first conductors is configured to supply power, neutral and ground for said first circuit, said set of first conductors includes pair of first power conductor, a first neutral conductor and a first ground conductor, each of said first power and neutral conductors having insulated sheathing, said insulated sheathing of said first power conductor having a first color, said insulated sheathing on said first neutral conductor has a stripe thereon being colored to correspond to said first color wherein said first neutral conductor is configured to be visually identifiable as the neutral for the first circuit;
a set of second conductors, each of said second conductors being placed in electrical communication with a second circuit wherein said set of second conductors is configured to supply power, neutral and ground for said second circuit, said set of second conductors includes pair of second power conductor, a second neutral conductor and a second ground conductor, each of said second power and neutral conductors having insulated sheathing, said insulated sheathing of said second power conductor having a second color, said insulated sheathing on said second neutral conductor has a stripe thereon being colored to correspond to said second color wherein said second neutral conductor is configured to be visually identifiable as the neutral for the second circuit;
a set of third conductors, each of said third conductors being placed in electrical communication with a third circuit wherein said set of third conductors is configured to supply power, neutral and ground for said third circuit, said set of third conductors includes pair of third power conductor, a third neutral conductor and a third ground conductor, each of said third power and neutral conductors having insulated sheathing, said insulated sheathing of said third power conductor having a third color, said insulated sheathing on said third neutral conductor has a stripe thereon being colored to correspond to said third color wherein said third neutral conductor is configured to be visually identifiable as the neutral for the third circuit;
a sleeve being positioned around each of said sets of first, second and third conductors, said sleeve being colored according to National Electrical Code with respect to the American Wire Gauge of said sets of first, second and third conductors; and
wherein said third ground conductor is centrally positioned extending along said sleeve, said first power conductor, said first neutral conductor, said second power conductor, said second neutral conductor, said third power conductor, and said third neutral conductor being arranged into a ring around said third ground conductor extending along said sleeve, each of said first ground conductor and said second ground conductor being positioned extending along said sleeve on diametrically opposed sides of said ring.
